(19) United States
(12) Patent Application Publication
(10) Pub. No.: US 2019/0181972 A1
(43) Pub. Date: Jun. 13, 2019

(54) SYSTEM AND METHOD FOR PROCESSING EMERGENCY ALERT MESSAGES

(71) Applicant: ARRIS Enterprises LLC, Suwanee, GA (US)

(72) Inventor: Krishna Prasad Panje, Bangalore (IN)

(21) Appl. No.: 15/835,079

(22) Filed: Dec. 7, 2017

(51) Int. Cl. H04H 20/59; H04N 21/81; H04N 21/488; H04N 21/43

(52) U.S. Cl. CPC H04H 20/59; H04N 21/43; H04N 21/4882; H04N 21/814

(57) ABSTRACT

A device includes a receiver, a first decoder, a second decoder, a packet generator and a transmitter. The receiver receives broadcast data as a combination of encoded content data from the content source and encoded emergency alert service data from an emergency alert service source. The first decoder generates decoded content data based on the encoded content data. The second decoder generates decoded emergency alert service data based on the encoded emergency alert service data. The packet generator generates streaming packets based on the received broadcast data. The transmitter transmits the streaming packets to the wireless content receiving device. When the received broadcast data is the combination of encoded content data from the content source and encoded emergency alert service data from an emergency alert service source, the packet generator generates the streaming packets by modifying the decoded content data based on the decoded emergency alert service

### BACKGROUND OF THE INVENTION

The present invention generally relates to using a set top box (STB) to process emergency alert system messages.

There exists a need for a system and method to process emergency alert system messages in a manner such that they can be streamed to, and used by, client devices.

### SUMMARY OF THE INVENTION

An aspect of the present invention is drawn to a device for use with a wireless content receiving device. The device includes a receiver, a first decoder, a second decoder, a packet generator and a transmitter. The receiver receives broadcast data as one of encoded content data from a content source and a combination of encoded content data from the content source and encoded emergency alert service data from an emergency alert service source. The first decoder generates decoded content data based on the encoded content data. The second decoder generates decoded emergency alert service data based on the encoded emergency alert service data. The packet generator generates streaming packets based on the received broadcast data. The transmitter transmits the streaming packets to the wireless content receiving device. When the received broadcast data is the combination of encoded content data from the content source and encoded emergency alert service data from an emergency alert service source, the packet generator generates the streaming packets by modifying the decoded content data based on the decoded emergency alert service.

### BRIEF SUMMARY OF THE DRAWINGS

The accompanying drawings, which are incorporated in and form a part of the specification, illustrate example embodiments and, together with the description, serve to explain the principles of the invention. In the drawings:

FIG. 1 illustrates a prior art media streaming system;

FIG. 2 illustrates a portion of a content data stream;

FIG. 3A illustrates a prior art STB providing content to a television;

FIG. 3B illustrates the prior art STB streaming content to a wireless client device;

FIG. 4A illustrates a prior art STB providing content and an EAS message to a television;

FIG. 4B illustrates the prior art STB streaming content and an EAS message to a wireless client device;

FIG. 5 illustrates an example media streaming system in accordance with aspects of the present invention;

FIG. 6 illustrates method of streaming content and EAS messages to a client device in accordance with aspects of the present invention;

FIG. 7 illustrates the example media streaming system of FIG. 5 receiving broadcast data;

FIG. 8 illustrates the example media streaming system of FIG. 5 after receiving broadcast data;

FIG. 9 illustrates the example media streaming system of FIG. 5 after generating streaming packets; and

FIG. 10 illustrates a device transmitting a packet stream to a client device in accordance with aspects of the present invention.

### DETAILED DESCRIPTION OF THE EMBODIMENTS

Aspects of the present invention are drawn to a system and method for using a STB to process emergency alert system (EAS) messages received on a transport stream into a format that can be wirelessly streamed to, and played by, a client device.

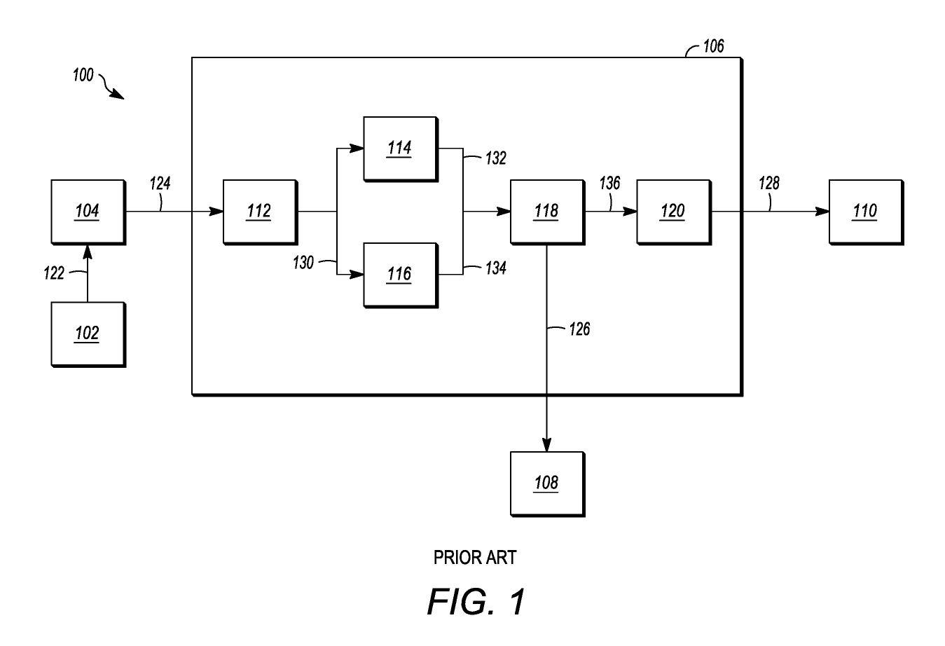

A prior art system for providing EAS messages with content will now be described with reference to FIGS. 1-4B.

FIG. 1 illustrates a prior art media streaming system 100.

As shown in the figure, media streaming system 100 includes an EAS message source 102, a content server 104, and, a STB 106, a television 108, and client device 110. STB 106 further includes a receiver 112, a content decoder 114, an EAS decoder 116, a packet generator 118, and a transmitter 120.

EAS message source 102 is arranged to provide EAS messages to content server 104 via a communication channel 122. Content server 104 is arranged to provide content data or a combination of content data and EAS message data to STB 106 via a communication channel 124. STB 106 is arranged to provide data to television 108 via a communication channel 126 and to wirelessly provide data to client device 110 via a wireless communication channel 128.

In this example, receiver 112, content decoder 114, EAS decoder 116, packet generator 118, and transmitter 120 are illustrated as individual devices. However, in some embodiments, at least two of receiver 112, content decoder 114, EAS decoder 116, packet generator 118, and transmitter 120 may be combined as a unitary device. Further, in some embodiments, at least one of receiver 112, content decoder 114, EAS decoder 116, packet generator 118, and transmitter 120 may be implemented as a computer having tangible computer-readable media for carrying or having computer-executable instructions or data structures stored thereon. Such tangible computer-readable media can be any available media that can be accessed by a general purpose or special purpose computer. Non-limiting examples of tangible computer-readable media include physical storage and/or memory media such as RAM, ROM, EEPROM, CD-ROM or other optical disk storage, SD cards, magnetic disk storage or other magnetic storage devices, or any other medium which can be used to carry or store desired program code means in the form of computer-executable instructions or data structures and which can be accessed by a general purpose or special purpose computer. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

EAS message source 102 provides EAS messages to content server 104. In some situations, the EAS messages may take the form of text data to warn of impending or current emergencies, such as weather emergencies. In some situations, the EAS message may take the form of sounds, such as repetitive high pitch sounds, to warn of impending or current emergencies. In some situations, the EAS message may take the form of sound and images to warn of impending or current emergencies.

Content server 104 provides content data to STB 106. Non-limiting examples of content provided by content server 104 include previously recorded shows and live broadcast shows. In cases where EAS message source 102 provides EAS messages to content server 104, content server 104 retransmits these EAS messages to STB 106. In such cases, the modified content provided by content server 104 is a combination of the content data and the EAS messages from EAS message source 102.

In an example embodiment, broadcast data provided by content server 104 is a transport stream. A transport stream is a standard digital container format for transmission of audio and video data. The transport stream specifies a container format encapsulating packetized elementary streams.

A transport stream is a stream that made up of elementary streams, packet identifiers (PID), and program map tables (PMT). An elementary stream is merely a sequence of packets, where a packet is a basic unit of data contains a payload for an elementary stream that is identified by a PID. Each elementary stream in a transport stream has its own unique PID. This unique PID allows elementary streams to be demultiplexed by only extracting packets with a PID that matches the elementary stream PID.

Transport streams also have the concept of programs. Every single program is described by a PMT, which has a unique PID, and the elementary streams associated with that program have PID's listed in the PMT. For instance, a transport stream used in a digital television might contain three programs in order to represent three channels.

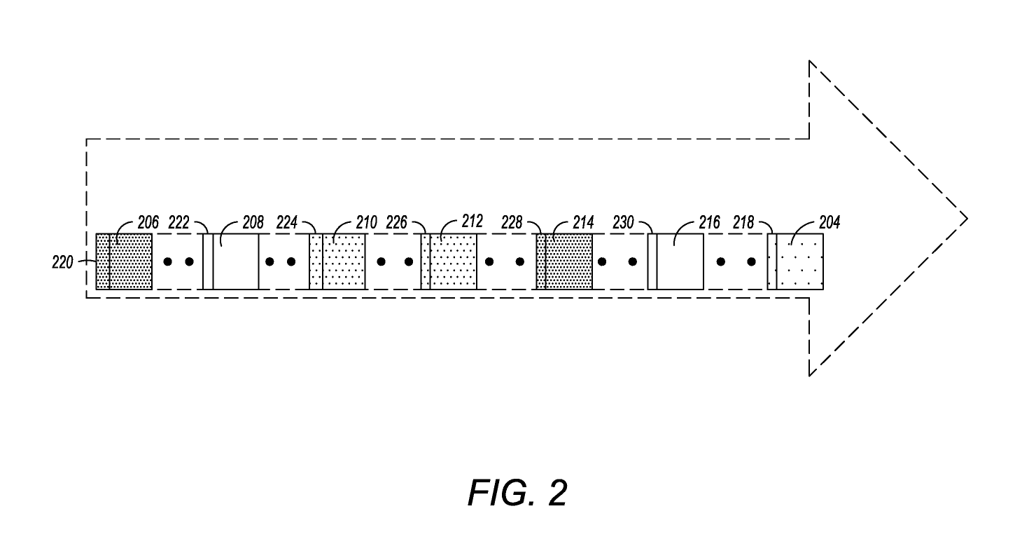

Suppose that each channel consists of one video stream and an audio stream. A receiver wishing to decode a particular channel merely has to decode the payloads of each PID associated with its program and discard the contents of all other PIDS. This will be described with additional reference to FIG. 2.

FIG. 2 illustrates a portion of a content data stream 202.

As illustrated in the figure, content data stream 202 includes a PMT packet 204 and a plurality of data packets, a sample of which are indicated as a content video packet 206, a content audio packet 208, an EAS packed 210, an EAS packet 212, a content video packet 214 and a content audio packet 216. Each packet includes a respective PID in the header. For example, PMT packet 204 includes a PMT PID 218, content video packet PID 220, a content audio packet PID 222, an EAS packet PID 224, an EAS packet PID 226, a content video packet PID 228 and a content audio packet PID 230.

PIDs are used to identify packets associated with a content stream being viewed by a user. PMT PID 218 is additionally used to identify packets associated with specific content streams and EAS streams.

Content video packet 206 and content video packet 214 carry a content video payload associated with specific content, e.g. video of a movie. Content audio packet 208 and content audio packet 216 carry a content audio payload associated with specific content, e.g. sound of the movie. EAS packet 210 and EAS packet 212 carry an EAS payload associated with a specific EAS message.

Returning to FIG. 1, content decoder 114 is operable to generate decoded content data based on the encoded content data of the broadcast data provided by receiver 112. Content decoder 114 is additionally operable to transmit the decoded content data to packet generator 118, via communication channel 132.

EAS decoder 116 is operable to generate decoded EAS data based on the encoded EAS data of the broadcast data provided by receiver 112. EAS decoder 116 is additionally operable to transmit the decoded EAS data to packet generator 118 via communication channel 134.

Packet generator 118 is operable to receive decoded content data provided by content decoder 114 and decoded EAS data provided by EAS decoder 116. Packet generator 118 may provide the content and EAS data to television 108 via communication channel 126 and may provide the content and EAS data to transmitter 120 via communication channel 136.

Transmitter 118 is able to stream the content and EAS data to wireless client device 110 via wireless communication channel 128.

In operation, when a user is streaming content from a content server, the content stream is given a unique PID, which is then added to the PMT of the transport stream along with the unique PID of any other streams. In this manner, any device receiving the transport stream can retrieve each of the unique PID's from the PMT, which can then be used to identify packets with a matching PID while ignoring all other packets within the stream.

Returning to FIG. 1, consider the situation wherein content server 104 provides broadcasts data to STB 106, wherein the broadcast data does not include any EAS messages. In this case, content server 104 provides the broadcast data as a transport stream to receiver 112 via communication channel 124. Receiver 112 then provides the received broadcast data to content decoder 114 and EAS decoder 116 by way of communication channel 130. Content decoder 114 decodes the transport stream to identify and organize the content data. Similarly, EAS decoder 116 decodes the transport stream to identify and organize the EAS message—if any. In this example situation, there is no EAS message, so EAS decoder 116 provides no decoded EAS message.

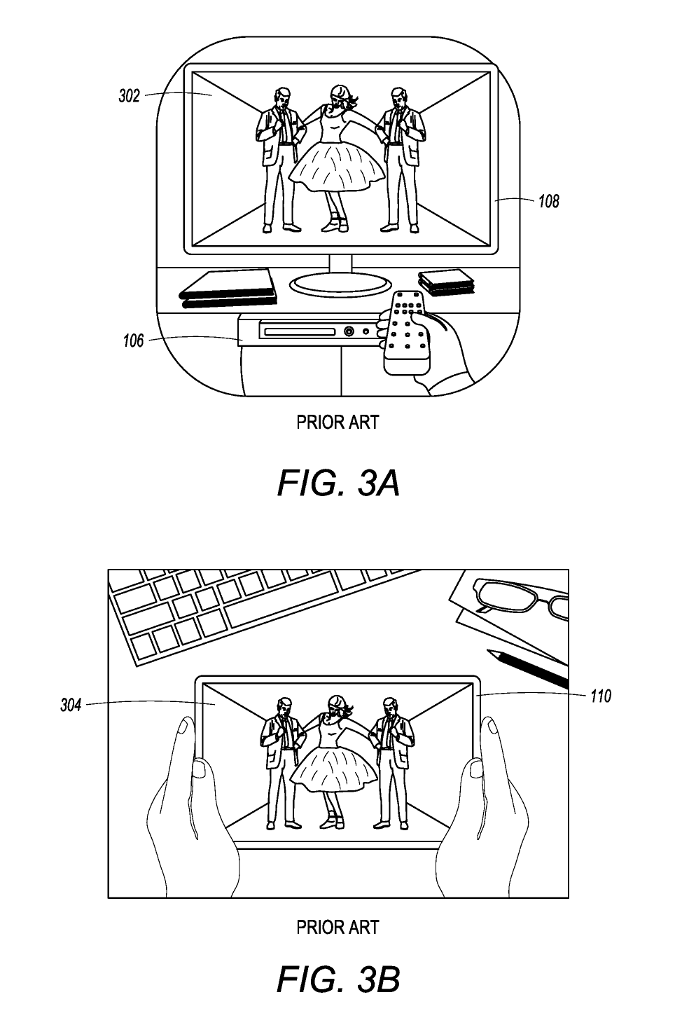

Content decoder 114 provides the decoded content data to packet generator 118 via communication channel 132. If a user decides to watch the content on a television, packet generator 118 provides the decoded content to television 108 via communication channel 126. This is illustrated in FIG. 3A.

As shown in FIG. 3A, STB 106 provides content to television 108 for viewing as audio video data 302.

In some situations, a user may want to stream the content to a wireless device, for example to watch the content in another room. Returning to FIG. 1, in the case of streaming content, packet generator provides the decoded content to transmitter 120 via communication channel 136. Transmitter 120 then transmits the decoded content to wireless client device 110 via wireless communication channel 128. This is illustrated in FIG. 3B.

As shown in FIG. 3B, STB 106 (not shown) provides content to client device 110 for viewing as audio video data 304.

Generally, as per FCC regulations, STBs should offer media transport and remote control pass through using open industry standards such as those of the Digital Living Network Alliance (DLNA). The DLNA is an alliance that was founded to develop and promote a set of interoperability guidelines for sharing digital media among multimedia devices under a certification standard.

To meet this regulation, STBs provide DLNA based streaming to stream content from STBs to client devices that are DLNA compliant. During DLNA streaming, a STB handles EAS messages by tuning to an EAS channel to receive the EAS audio and video content, which is then processed such that it is in a condition to be streamed and played by the client device since the client devices are not able to process the EAS messages directly.

An issue with this process is that there are no guidelines on how the EAS alert should be processed in order to be displayed properly by client devices. As such, EAS messages that are streamed to client devices are simply ignored as of now. Currently, EAS alerts are transmitted using a unique PID, which prevents the EAS alert from being displayed by a client device. For example, if a user is enjoying streamed content from a client device, such as a smart phone, the television may be turned off or a user may not be near it. During this time, if an EAS alert is issued, the EAS alert is ignored since it arrives on a separate PID from the streamed content and the client device is a non-cable set top device that is not able to process the message.

For example, returning to FIG. 1, consider the situation wherein EAS message source 102 provides an EAS message to content server 104 via a communication channel 122. Content server 104 provides broadcasts data and the EAS message to STB 106. In this case, content server 104 provides the broadcast data and EAS message as a transport stream to receiver 112 via communication channel 124. Receiver 112 then provides the received broadcast data and EAS message to content decoder 114 and EAS decoder 116 by way of communication channel 130. Content decoder 114 decodes the transport stream to identify and organize the content data. Similarly, EAS decoder 116 decodes the transport stream to identify and organize the EAS message.

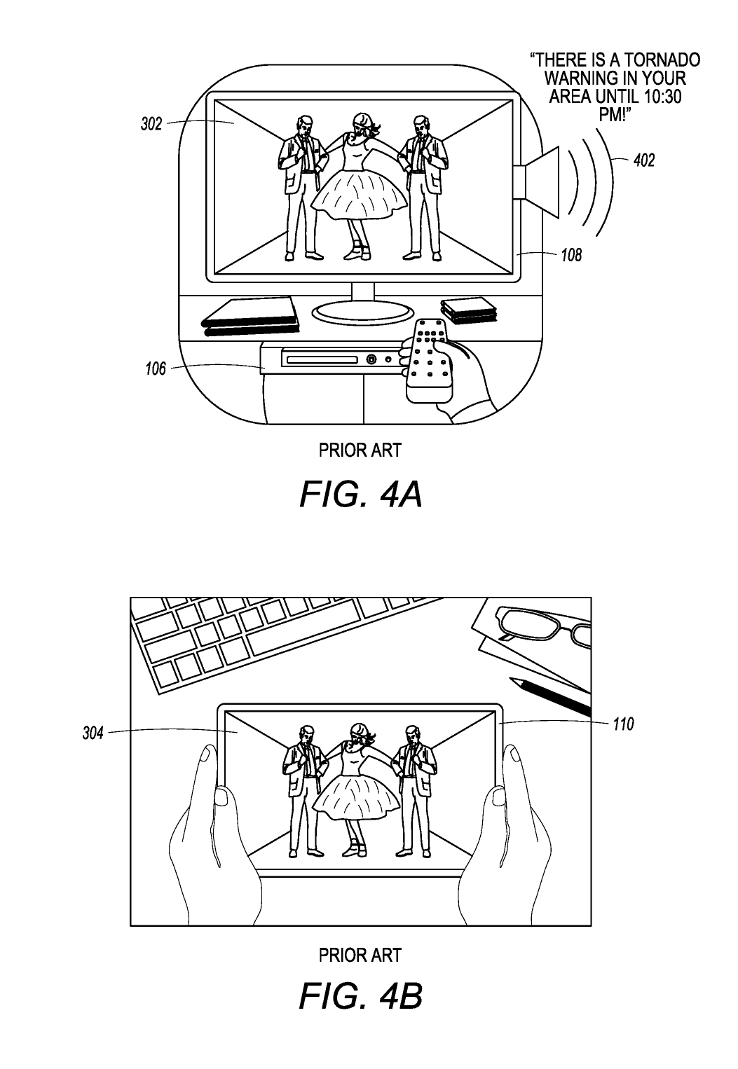

Content decoder 114 provides the decoded content data to packet generator 118 via communication channel 132, whereas EAS decoder provides the decoded EAS message data to packet generator 118 via communication channel 134. If a user decides to watch the content on a television, packet generator 118 provides the decoded content and EAS message to television 108 via communication channel 126. This is illustrated in FIG. 4A.

As shown in FIG. 4A, STB 106 provides content and an EAS message to television 108 for viewing as audio video data 302 in addition to audio EAS data 402. It should be noted that the EAS message may take any known form, non-limiting examples of which include images, sounds and a combination thereof.

Again, in some situations, a user may want to stream the content to a wireless device, for example to watch the content in another room. Returning to FIG. 1, in the case of streaming content, packet generator provides the decoded content and EAS message to transmitter 120 via communication channel 136. Transmitter 120 then transmits the decoded content and decoded EAS message to wireless client device 110 via wireless communication channel 128. Unfortunately, as discussed above, currently, client devices that stream content are unable to use the EAS message with the content. This is illustrated in FIG. 4B.

As shown in FIG. 4B, STB 106 (not shown) provides content and an EAS message to client device 110 for viewing as audio video data 304. However, as shown in the figure, the EAS message that would have been provided if the content was viewed on television 108, as shown in FIG. 4A, is not provided to the user of client device 110.

What is needed is a system and method to provide EAS messages to a wireless streaming device so that a user of the streamed content can be aware of the EAS messages.

Aspects of the present invention provide EAS messages to a wireless streaming device so that a user of the streamed content can be aware of the EAS messages.

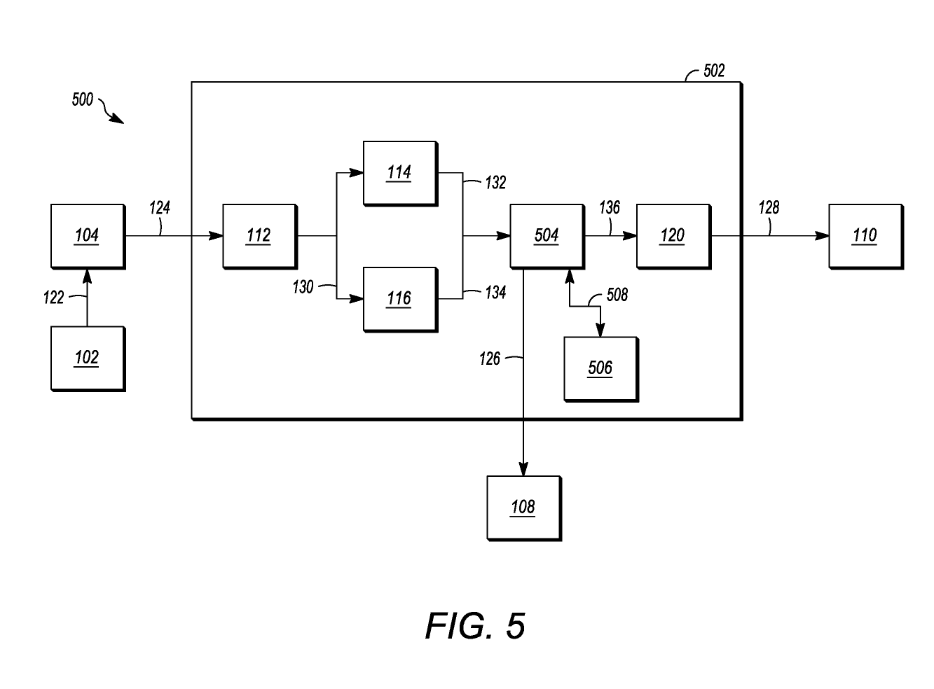

Aspects of the present invention will now be described with reference to FIGS. 5-10.

FIG. 5 illustrates a art media streaming system 500 in accordance with aspects of the present invention.

As shown in the figure, media streaming system 500 includes the elements of prior art media streaming system 100 discussed above with reference to FIG. 1, wherein STB 106 is replaced with STB 502. More specifically, STB 502 differs from STB 106 in that packet generator 118 of STB 106 is replaced with a packet generator 504 in STB 502, and SBT 502 additionally includes a memory 506.

In this example, receiver 112, content decoder 114, EAS decoder 116, packet generator 504, memory 506 and transmitter 120 are illustrated as individual devices. However, in some embodiments, at least two of receiver 112, content decoder 114, EAS decoder 116, packet generator 504, memory 506 and transmitter 120 may be combined as a unitary device. Further, in some embodiments, at least one of receiver 112, content decoder 114, EAS decoder 116, packet generator 504, memory 506 and transmitter 120 may be implemented as a computer having tangible computer-readable media for carrying or having computer-executable instructions or data structures stored thereon.

Packet generator 504 is operable to receive decoded content data provided by content decoder 114 and decoded EAS data provided by EAS decoder 116. Packet generator 504 is additionally able to provide the content and EAS data to television 108 via communication channel 126 and may provide the content and EAS data to transmitter 120 via communication channel 136. In one example embodiment, packet generator 504 is operable to generate streaming packets based on the received content data and emergency alert service data.

In another example embodiment, packet generator 504 is operable to generate streaming packets by modifying the decoded audio content based on the decoded emergency alert service data.

In another example embodiment, packet generator 504 is operable to generate streaming packets by mixing sound data received from memory 506, via communication channel 126, with the audio content data of the decoded content data.

In yet another example embodiment, packet generator 504 is operable to generate streaming packets by replacing the audio content data of the decoded content data with sound data received from memory 506, via communication channel 126.

Packet generator 504 is additionally operable to provide the streaming packets it generates to transmitter 118, via communication channel 128.

Memory 506 is operable to provide stored sound data to packet generator 504, via communication channel 126.

When providing content data or a combination of content data and EAS messages to television 108, STB 502 operates in a manner similar to STB 106 discussed above with reference to FIG. 1. In particular, when providing content data or a combination of content data and EAS messages to television 108, packet generator 504 operates in a manner similar to packet generator 118.

When providing a combination of content data and EAS messages to client device 110, STB 502 operates in an improved manner over STB 106 discussed above with reference to FIG. 1. In particular, when providing a combination of content data and EAS messages to client device 110, packet generator 504 operates in an improved manner over packet generator 118.

In accordance with aspects of the present invention, when a combination of content and an EAS message is received, the STB modifies the data to be provided to the client device so that the client device may be alerted to an existence of the EAS message.

In one embodiment, when a combination of content and an EAS message is received, the STB replaces or mixes the content audio with stored audio data that is associated with the EAS massage. For example, stored “beep” audio may be included with the content data so that a “beep” will then be played by the client device in order to alert the user that there is an EAS message that they should watch.

Alternatively, when an EAS message is received that contains audio data; the STB may modify the program map table (PMT) of the transport stream such that it would indicate that the EAS audio is the primary audio channel. When processed by the client device, it would play the EAS audio data rather than the media audio data in order to alert the user.

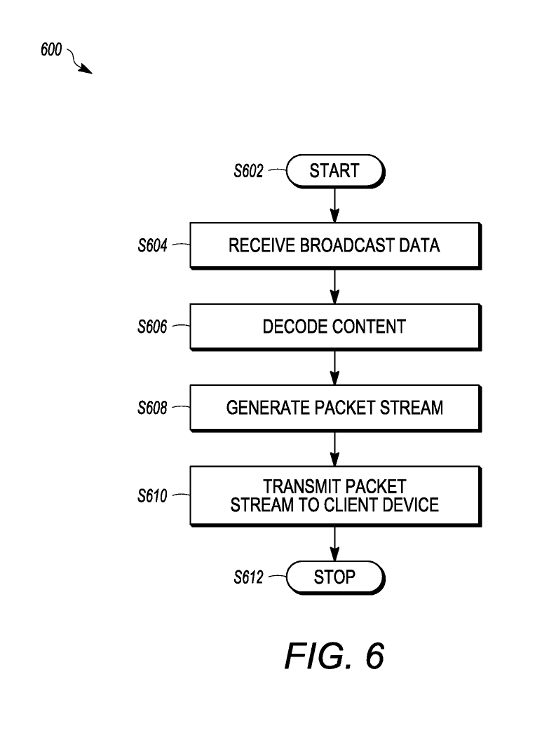

An example method 600 for streaming content data and EAS massages to a client device in accordance with aspects of the present invention will now be described with additional reference to FIGS. 6-10.

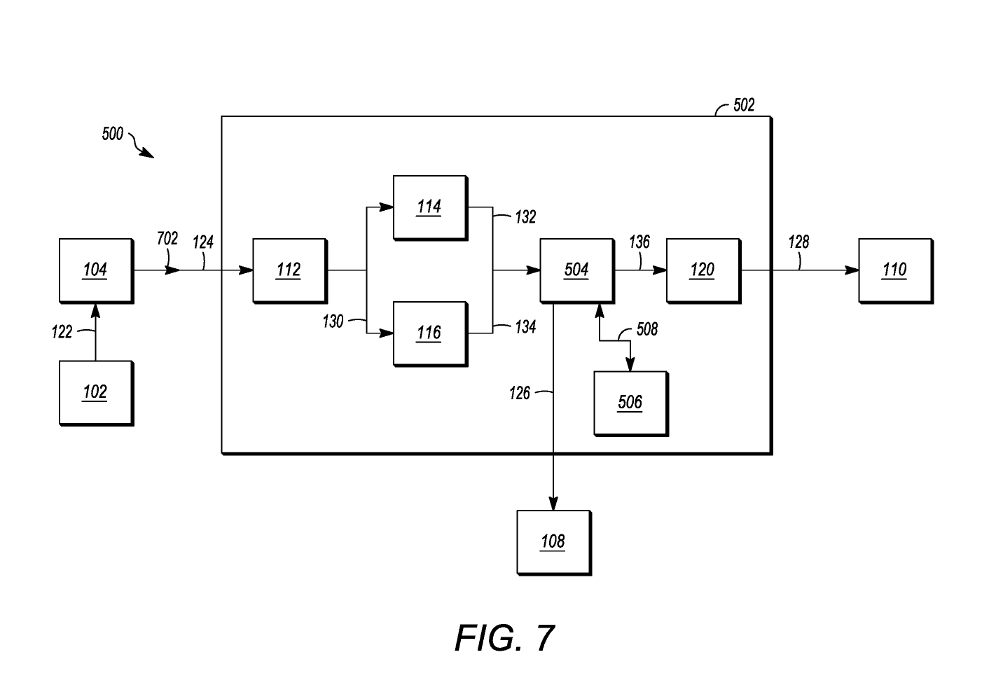

As shown in FIG. 6, method 600 starts (S602) and STB 502 receives broadcast data 702 (S604). For example, as shown in FIG. 7, suppose a user is streaming content from content server 104 and watching it on client device 104. In this example embodiment, content server 104 provides broadcast data 702 to receiver 112 of STB 502, via communication channel 112. At some point during the user streaming content from content server 104, an EAS alert is issued. In particular, when the EAS alert is issued, EAS message source 102 provides an EAS message to content server 104 via communication channel 122. Content server 104 then inserts encoded EAS alert data is inserted into the encoded content data to provide broadcast data 702. This broadcast data is then transmitted to STB 502 via communication channel 124. Once broadcast data 702 is transmitted by content server 104, it is received by receiver 108 of STB 502.

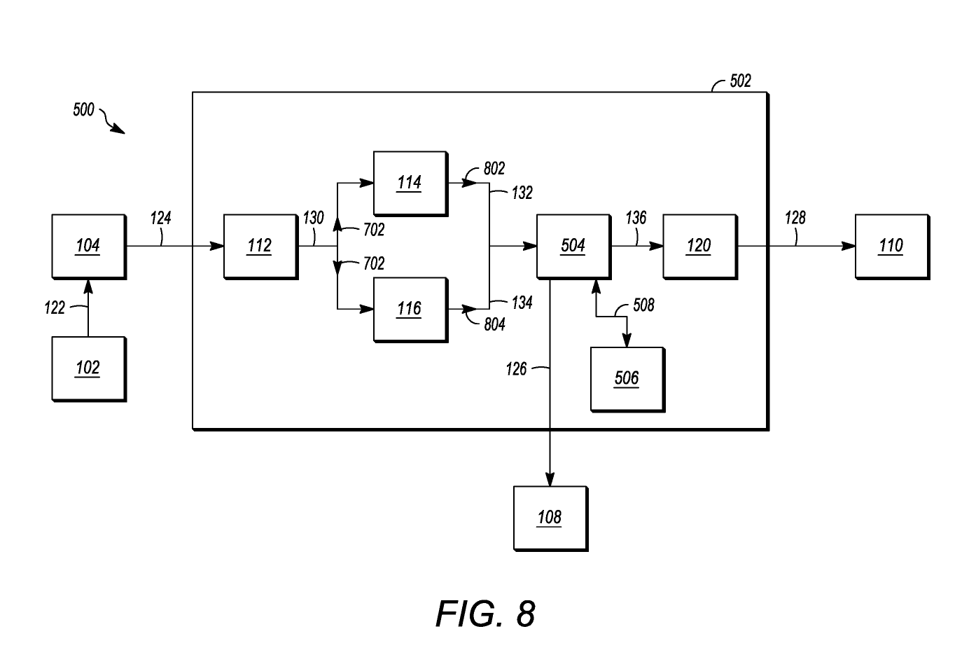

Returning to FIG. 6, after broadcast data is received (S604), it is decoded (S606). For example, as shown in FIG. 8, upon receiving broadcast data 702, receiver 108 provides broadcast data 702 to each of content decoder 114 and EAS decoder 116, via communication channel 130 so that it may be decoded.

After receiving broadcast data 702, content decoder 114 and EAS decoder 116 begin to decode the content stream and EAS stream within in order to retrieve the data associated with each stream.

To begin, when content decoder 114 receives broadcast data 702, it first must obtain the packets associated with the content stream. For purposes of discussion, consider content data stream 202 discussed above with reference to FIG. 2. In this embodiment, content decoder 114 retrieves the PMT from PMT packet 204 from broadcast stream 702 and finds the PIDs associated with the content stream. In this example, the PIDs associated with content include content video packet 206, content audio packet 208, content video packet 214 and content audio packet 216. Next, content decoder 114 decodes packets within broadcast data 702 that are identified by PMT from PMT packet 204, which in this example include content video packet 206, content audio packet 208, content video packet 214 and content audio packet 216. After decoding, each packet is transmitted to packet generator 504 as decoded content data 802, via communication channel 132.

Simultaneously, EAS decoder 116 receives broadcast data 702 and determines that the packets associated with the EAS message include EAS packed 210 and EAS packet 212. Next, EAS decoder 116 decodes EAS packet 210 and EAS packet 212, which it then transmits to packet generator 504 as decoded EAS data 804, via communication channel 134.

Once the content data packets and the EAS data packets have been decoded, they are transmitted to packet generator 504. Packet generator 504 will then generate a packet stream and PMT that may be used by either television 108 or client device 110.

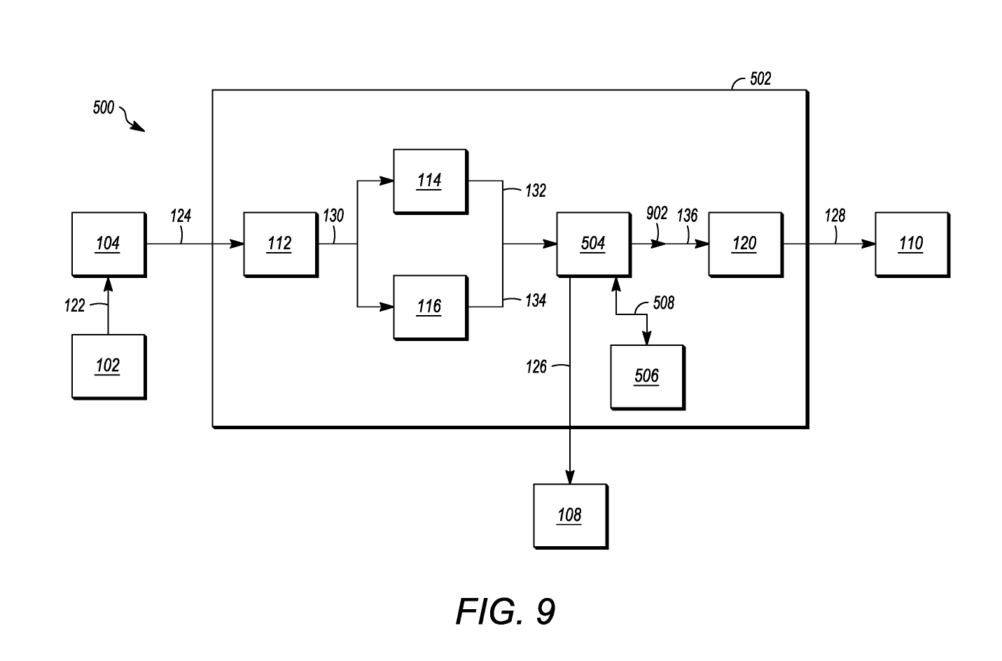

Returning to FIG. 6, after the broadcast data is decoded (S606) the decoded data must be used by the packet generator in order to generate a packet stream (S608). For example, as shown in FIG. 9, once packet generator 504 receives decoded content data 802 and decoded EAS data 804 it generates streaming packets based on a combination of decoded content data 802 and decoded EAS data 804 in a manner such that it may be usable by client device 104.

In one example, as shown in FIG. 5, packet generator 504 replaces the content audio with pre-encoded and stored EAS beep audio. For example, memory 506 may have stored therein pre-encoded EAS beep audio data. Packet generator 504 will recognize EAS data as decoded by EAS decoder 116. As shown in FIG. 2, for example packet generator 504 may identify EAS packet 210 and EAS packet 212. In response to the EAS packet identification, packet generator 504 may access memory 506 via communication channel 508 to obtain the pre-encoded EAS beep audio data. At this point, packet generator 504 will replace EAS packet 210 and EAS packet 212 with the pre-encoded EAS beep audio data.

This EAS beep audio data that replaces EAS packet 210 and EAS packet 212 is pre-encoded in a manner such that client device 110 can decode and play the EAS beep audio data.

In prior art systems, a client device may know be able to decode audio data associated with an EAS message. However, in accordance with the present invention, the audio data associated with an EAS message is modified such that the client device can decide the audio data associated with an EAS message. Now, the client will play out the beep audio and the user will be alerted. The beep audio may verbally direct the user to watch television 108, which may additionally display scrolling EAS message text.

In another example, if the EAS message contains any audio (which is optional), then packet generator 504 may indicate that the decoded audio EAS data as the decoded audio content data. For example, in one embodiment, packet generator 504 may modify the PMT of the streamed transport such that the EAS audio data is the default audio data. Packet generator 504 will recognize EAS data as decoded by EAS decoder 116. As shown in FIG. 2, for example packet generator 504 may identify EAS packet 210 and EAS packet 212. In response to the EAS packet identification, packet generator 504 may then modify the PMT in PMT packet 204 to indicate that EAS packet 210 and EAS packet 212 are the default audio packets.

When client device 110 then receives the transmitted content and EAS data, the audio data directed by the PMT in PMT packet 204 instructs client device 110 to play the EAS audio as opposed to the content audio. As such, client device 110 can decode and play the EAS audio data.

In prior art systems, a client device may “see” two sources of audio data, the content audio data and the EAS message audio data. However, the content audio data is the priority audio data as indicated in PMT of PMT packet 204. Accordingly, in prior art systems, the client device ignores the EAS message audio data. However, in accordance with an aspect of the present invention, the audio data associated with an EAS message tagged as the priority audio data in the PMT of PMT packet 204. Now, the client will play out the EAS audio and the user will be alerted.

In another example, the user may set different audible alerts depending upon the EAS event codes.

In one example, as shown in FIG. 5, packet generator 504 replaces the content audio with pre-encoded and stored EAS audio for specifically delineated EAS messages. For example, memory 506 may have stored therein a plurality pre-encoded EAS audio data for a respective plurality of different EAS messages. For example, an EAS message regarding a tornado may have a specific audio tone, whereas an EAS message regarding a missing child would have a different specific audio tone. The relationships between predetermined EAS messages and pre-encoded EAS audio data may be stored in memory 506 in any known manner, a non-limiting example of which includes a look-up table.

Packet generator 504 will recognize EAS data as decoded by EAS decoder 116. As shown in FIG. 2, for example packet generator 504 may identify EAS packet 210 and EAS packet 212. In response to the EAS packet identification, packet generator 504 may access memory 506 via communication channel 508 to obtain the pre-encoded EAS audio data associated with the specific EAS message of EAS packet 210 and EAS packet 212. At this point, packet generator 504 will replace EAS packet 210 and EAS packet 212 with the specifically associated pre-encoded EAS audio data.

Again, this EAS audio data that replaces EAS packet 210 and EAS packet 212 is pre-encoded in a manner such that client device 110 can decode and play the EAS audio data.

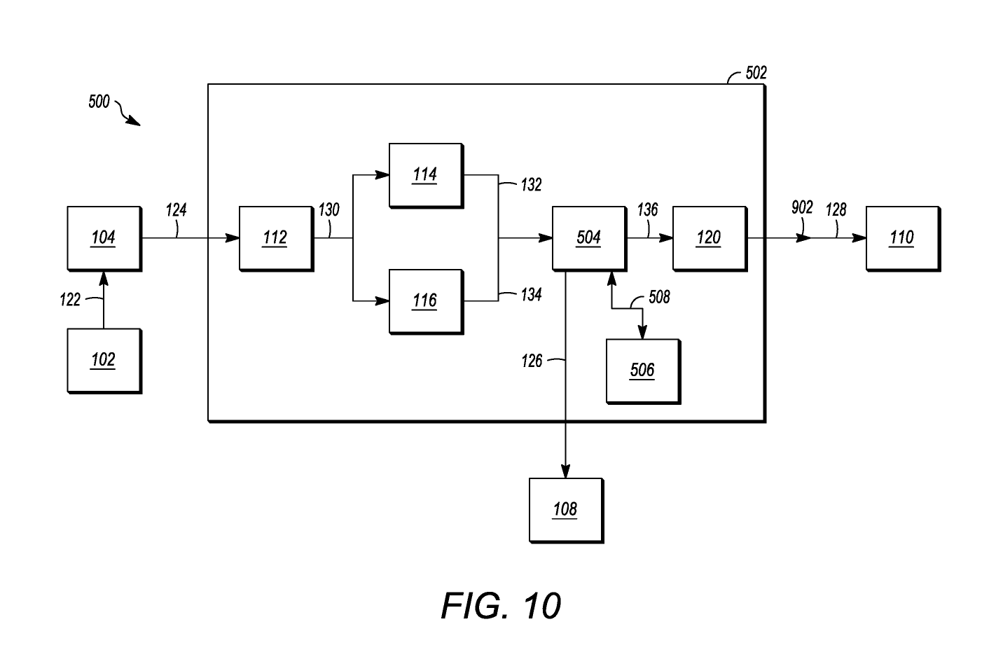

Returning to FIG. 6, after the packet stream is generated (S608) it is transmitted to client the client device (S610). For example, as shown in FIG. 10, once packet generator 504 provides packet stream 902 to transmitter 118. Transmitter 118 then transmits packet stream 902 to client device 104, via communication channel 130. After receiving packet stream 902, client device 104 will process and play the data. In this manner, client device 104 is able to be alerted to incoming EAS messages using a plurality of different methods. Returning to FIG. 6, after packet stream 902 is transmitted to the client device (S610), method 600 stops (S612).

In summary, a problem with the current system and method for handling EAS messages is that currently client devices are unable to process EAS alerts. Since the client devices cannot process the EAS messages, the messages must processed by the STB before being transmitted to the client device. The problem with this method of handling EAS messages is that there is currently no guidance or regulations on how the EAS messages should be processed in order to be displayed by client devices.

The present invention solves this problem by processing the EAS message and inserting it into a packet stream that is then transmitted to the client device. The STB may replace or mix the streamed content audio with pre-encoded and stored EAS beep audio which will then alert the user of the client device.

Alternatively, the STB may modify the program map table of the packet stream in order to indicate that the EAS audio is the primary audio channel that should be played by the client device. In this manner, the client device would play the EAS audio rather than the content audio in order to alert the user.

Another alternative is that the user may set different types of audible alerts for different types of EAS alerts and they may also set the method the STB uses to process the EAS alerts depending on the severity or type of alert. In this method, the STB may process EAS alerts in a manner that is preferred by the user of a client device.

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A device for use with a wireless content receiving device, said device comprising:
a receiver operable to receive broadcast data as one of encoded content data from a content source and a combination of encoded content data from the content source and encoded emergency alert service data from an emergency alert service source;
a first decoder operable generate decoded content data based on the encoded content data;
a second decoder operable to generate decoded emergency alert service data based on the encoded emergency alert service data;
a packet generator operable to generate streaming packets based on the received broadcast data; and
a transmitter operable to transmit the streaming packets to the wireless content receiving device,
wherein when the received broadcast data is the combination of encoded content data from the content source and encoded emergency alert service data from an emergency alert service source, said packet generator is operable to generate the streaming packets by modifying the decoded content data based on the decoded emergency alert service data.

2. The device of claim 1, further comprising:
a storage component having sound data stored therein,
wherein the decoded content data includes decoded audio content data, and
wherein when the received broadcast data is the combination of encoded content data from the content source and encoded emergency alert service data from an emergency alert service source, said packet generator is operable to modify the decoded audio content data with the sound data.

3. The device of claim 2, wherein when the received broadcast data is the combination of encoded content data from the content source and encoded emergency alert service data from an emergency alert service source, said packet generator is operable to replace the decoded audio content data with the sound data.

4. The device of claim 2, wherein when the received broadcast data is the combination of encoded content data from the content source and encoded emergency alert service data from an emergency alert service source, said packet generator is operable to mix the decoded audio content data with the sound data.

5. The device of claim 1,
wherein the decoded content data includes decoded audio content data, and
wherein the decoded emergency alert service data includes decoded audio emergency alert service data, and
wherein when the received broadcast data is the combination of encoded content data from the content source and encoded emergency alert service data from an emergency alert service source, said packet generator is operable to replace the decoded audio content data with the decoded audio emergency alert service data.

6. The device of claim 1, further comprising:
a storage component having first sound data stored therein and second sound data stored therein,
wherein the decoded content data includes decoded audio content data,
wherein the decoded emergency alert service data includes decoded audio emergency alert service data as one of a first event audio emergency alert service data and a second event audio emergency alert service data,
wherein when the received broadcast data is the combination of encoded content data from the content source and encoded emergency alert service data from an emergency alert service source and when the decoded audio emergency alert service data is the first event audio emergency alert service data, said packet generator is operable to modify the decoded audio content data with the first sound data, and
wherein when the received broadcast data is the combination of encoded content data from the content source and encoded emergency alert service data from an emergency alert service source and when the decoded audio emergency alert service data is the second event audio emergency alert service data, said packet generator is operable to modify the decoded audio content data with the second sound data.

7. The device of claim 1,
wherein the decoded content data includes decoded audio content data, and
wherein the decoded emergency alert service data includes decoded audio emergency alert service data, and
wherein when the received broadcast data is the combination of encoded content data from the content source and encoded emergency alert service data from an emergency alert service source, said packet generator is operable to indicate the decoded audio emergency alert service data as the decoded audio content data.

8. A method of streaming to a wireless content receiving device, said method comprising:
receiving, via a receiver, broadcast data as one of encoded content data from a content source and a combination of encoded content data from the content source and encoded emergency alert service data from an emergency alert service source;
generating, via a first decoder, decoded content data based on the encoded content data;
generating, via a second decoder, decoded emergency alert service data based on the encoded emergency alert service data when the received broadcast data is the combination of encoded content data from the content source and encoded emergency alert service data from an emergency alert service source;
generating, via a packet generator, streaming packets based on the received broadcast data; and
transmitting, via a transmitter, the streaming packets to the wireless content receiving device,
wherein when the received broadcast data is the combination of encoded content data from the content source and encoded emergency alert service data from an emergency alert service source, said generating, via a packet generator, streaming packets based on the received broadcast data comprises generating, via the packet generator, the streaming packets by modifying the decoded content data based on the decoded emergency alert service data.

9. The method of claim 8, further comprising:
storing, into a storage component, sound data,
wherein the decoded content data includes decoded audio content data, and
wherein when the received broadcast data is the combination of encoded content data from the content source and encoded emergency alert service data from an emergency alert service source, said generating, via a packet generator, streaming packets based on the received broadcast data comprises generating, via the packet generator, the streaming packets by modifying the decoded audio content data with the sound data.

10. The method of claim 9, wherein when the received broadcast data is the combination of encoded content data from the content source and encoded emergency alert service data from an emergency alert service source, said generating, via a packet generator, streaming packets based on the received broadcast data comprises generating, via the packet generator, the streaming packets by replacing the decoded audio content data with the sound data.

11. The method of claim 9, wherein when the received broadcast data is the combination of encoded content data from the content source and encoded emergency alert service data from an emergency alert service source, said generating, via a packet generator, streaming packets based on the received broadcast data comprises generating, via the packet generator, the streaming packets by mixing the decoded audio content data with the sound data.

12. The method of claim 8,
wherein the decoded content data includes decoded audio content data, and
wherein the decoded emergency alert service data includes decoded audio emergency alert service data, and
wherein when the received broadcast data is the combination of encoded content data from the content source and encoded emergency alert service data from an emergency alert service source, said generating, via a packet generator, streaming packets based on the received broadcast data comprises generating, via the packet generator, the streaming packets by replacing the decoded audio content data with the decoded audio emergency alert service data.

13. The method of claim 8, further comprising:
storing, into a storage component, first sound data stored and second sound data,
wherein the decoded content data includes decoded audio content data,
wherein the decoded emergency alert service data includes decoded audio emergency alert service data as one of a first event audio emergency alert service data and a second event audio emergency alert service data,
wherein when the received broadcast data is the combination of encoded content data from the content source and encoded emergency alert service data from an emergency alert service source and when the decoded audio emergency alert service data is the first event audio emergency alert service data, said generating, via a packet generator, streaming packets based on the received broadcast data comprises generating, via the packet generator, the streaming packets by modifying the decoded audio content data with the first sound data, and
wherein when the received broadcast data is the combination of encoded content data from the content source and encoded emergency alert service data from an emergency alert service source and when the decoded audio emergency alert service data is the second event audio emergency alert service data, said generating, via a packet generator, streaming packets based on the received broadcast data comprises generating, via the packet generator, the streaming packets by modifying the decoded audio content data with the second sound data.

14. The method of claim 8,
wherein the decoded content data includes decoded audio content data, and
wherein the decoded emergency alert service data includes decoded audio emergency alert service data, and
wherein when the received broadcast data is the combination of encoded content data from the content source and encoded emergency alert service data from an emergency alert service source, said generating, via a packet generator, streaming packets based on the received broadcast data comprises generating, via the packet generator, the streaming packets by indicating the decoded audio emergency alert service data as the decoded audio content data.

15. A non-transitory, tangible, computer-readable media having computer-readable instructions stored thereon, the computer-readable instructions being capable of being read by a computer and being capable of instructing the computer to perform a method, of streaming data to a wireless content receiving device, comprising:
receiving, via a receiver, broadcast data as one of encoded content data from a content source and a combination of encoded content data from the content source and encoded emergency alert service data from an emergency alert service source;
generating, via a first decoder, decoded content data based on the encoded content data;
generating, via a second decoder, decoded emergency alert service data based on the encoded emergency alert service data when the received broadcast data is the combination of encoded content data from the content source and encoded emergency alert service data from an emergency alert service source;
generating, via a packet generator, streaming packets based on the received broadcast data; and
transmitting, via a transmitter, the streaming packets to the wireless content receiving device,
wherein when the received broadcast data is the combination of encoded content data from the content source and encoded emergency alert service data from an emergency alert service source, said generating, via a packet generator, streaming packets based on the received broadcast data comprises generating, via the packet generator, the streaming packets by modifying the decoded content data based on the decoded emergency alert service data.

16. The non-transitory, tangible, computer-readable media of claim 15, wherein the computer-readable instructions are capable of instructing the computer to perform the method further comprising:
storing, into a storage component, sound data,
wherein the decoded content data includes decoded audio content data, and
wherein when the received broadcast data is the combination of encoded content data from the content source and encoded emergency alert service data from an emergency alert service source, said generating, via a packet generator, streaming packets based on the received broadcast data comprises generating, via the packet generator, the streaming packets by modifying the decoded audio content data with the sound data.

17. The non-transitory, tangible, computer-readable media of claim 16, wherein the computer-readable instructions are capable of instructing the computer to perform the method such that when the received broadcast data is the combination of encoded content data from the content source and encoded emergency alert service data from an emergency alert service source, said generating, via a packet generator, streaming packets based on the received broadcast data comprises generating, via the packet generator, the streaming packets by replacing the decoded audio content data with the sound data.

18. The non-transitory, tangible, computer-readable media of claim 16, wherein the computer-readable instructions are capable of instructing the computer to perform the method such that when the received broadcast data is the combination of encoded content data from the content source and encoded emergency alert service data from an emergency alert service source, said generating, via a packet generator, streaming packets based on the received broadcast data comprises generating, via the packet generator, the streaming packets by mixing the decoded audio content data with the sound data.

19. The non-transitory, tangible, computer-readable media of claim 15, wherein the computer-readable instructions are capable of instructing the computer to perform the method
such that the decoded content data includes decoded audio content data, and
such that the decoded emergency alert service data includes decoded audio emergency alert service data, and
such that when the received broadcast data is the combination of encoded content data from the content source and encoded emergency alert service data from an emergency alert service source, said generating, via a packet generator, streaming packets based on the received broadcast data comprises generating, via the packet generator, the streaming packets by replacing the decoded audio content data with the decoded audio emergency alert service data.

20. The non-transitory, tangible, computer-readable media of claim 15, wherein the computer-readable instructions are capable of instructing the computer to perform the method further comprising:
storing, into a storage component, first sound data stored and second sound data,
wherein the decoded content data includes decoded audio content data,
wherein the decoded emergency alert service data includes decoded audio emergency alert service data as one of a first event audio emergency alert service data and a second event audio emergency alert service data,
wherein when the received broadcast data is the combination of encoded content data from the content source and encoded emergency alert service data from an emergency alert service source and when the decoded audio emergency alert service data is the first event audio emergency alert service data, said generating, via a packet generator, streaming packets based on the received broadcast data comprises generating, via the packet generator, the streaming packets by modifying the decoded audio content data with the first sound data, and
wherein when the received broadcast data is the combination of encoded content data from the content source and encoded emergency alert service data from an emergency alert service source and when the decoded audio emergency alert service data is the second event audio emergency alert service data, said generating, via a packet generator, streaming packets based on the received broadcast data comprises generating, via the packet generator, the streaming packets by modifying the decoded audio content data with the second sound data.
